(19) United States
(12) Patent Application Publication
(10) Pub. No.: US 2025/0004405 A1
(43) Pub. Date: Jan. 2, 2025

(54) FIXING DEVICE AND IMAGE FORMING SYSTEM

(71) Applicant: FUJIFILM Business Innovation Corp., Tokyo (JP)

(72) Inventors: Yoshiki Shimodaira, Kanagawa (JP); Masato Yamashita, Kanagawa (JP); Hideki Kuge, Kanagawa (JP); Takayuki Ukawa, Kanagawa (JP); Yutaka Kiuchi, Kanagawa (JP)

(73) Assignee: FUJIFILM Business Innovation Corp., Tokyo (JP)

(21) Appl. No.: 18/532,645

(22) Filed: Dec. 7, 2023

(30) Foreign Application Priority Data
Jun. 29, 2023 (JP) 2023-107570

(51) Int. Cl. G03G 15/20

(52) U.S. Cl. CPC G03G 15/206; G03G 15/2064; G03G 2215/2022

(57) ABSTRACT

A fixing device includes: a conveyor that conveys a recording medium in which a toner image is fixed onto a first face by heating and pressurizing and a toner image unfixed is held on a second face; a heating member that heats the toner image held on the second face of the recording medium conveyed by the conveyor in a contact state; a pressing member that pressurizes the recording medium against the heating member to fix the toner image held on the second face of the recording medium and contacts the toner image fixed onto the first face of the recording medium; and an irregular portion that is provided on a surface of the pressing member, has a plurality of protrusions and recesses, and has a difference in height between the recesses and the protrusions equal to or greater than a height of a toner layer in a solid toner image fixed onto the first face of the recording medium.

### CROSS-REFERENCE TO RELATED APPLICATIONS

This application is based on and claims priority under 35 USC 119 from Japanese Patent Application No. 2023-107570 filed Jun. 29, 2023.

### BACKGROUND

### (i) Technical Field

The present disclosure relates to a fixing device and an image forming system.

### (ii) Related Art

JP1993-303303A (JP-H05-303303A) discloses a fixing device that includes a heating roller and a pressure belt, heats and pressurizes a sheet holding a toner image, melts toner and fixes the toner to the sheet, in which the pressure belt is formed into an endless shape by a heat-resistant sheet, and a joint of the pressure belt is not orthogonal to a belt rotation direction.

JP1996-241000A (JP-H08-241000A) discloses a fixing device that includes a fixing roller and a pressing member disposed so as to be pressed against an outer peripheral surface of the fixing roller, and fixes an unfixed toner image on a recording material by conveying the recording material having the unfixed toner image between the fixing roller and the pressing member, in which a heat-resistant sheet having glass fiber as a base material is provided between the fixing roller, and the pressing member and the recording material is conveyed between the fixing roller and the heat-resistant sheet.

JP2002-139940A discloses a fixing roller that includes a release layer on a surface and an elastic layer under the release layer and is directly or indirectly heated by a heat source, in which the release layer on the surface is formed by a member having a lower thermal expansion coefficient or lower thermal shrinkability than the elastic layer and is attached so as to generate wrinkles on the surface when not heated.

### SUMMARY

Aspects of non-limiting embodiments of the present disclosure relate to a fixing device and an image forming system in which when a toner image on a second face of a recording medium is fixed after a toner image on a first face of the recording medium is fixed, gloss unevenness of an image due to melting of toner on the first face of the recording medium can be suppressed more than in a case where a surface of a pressing member is smooth.

Aspects of certain non-limiting embodiments of the present disclosure address the above advantages and/or other advantages not described above. However, aspects of the non- limiting embodiments are not required to address the advantages described above, and aspects of the non-limiting embodiments of the present disclosure may not address advantages described above.

According to an aspect of the present disclosure, there is provided a fixing device comprising: a conveyor that conveys a recording medium in which a toner image is fixed onto a first face by heating and pressurizing and a toner image unfixed is held on a second face; a heating member that heats the toner image held on the second face of the recording medium conveyed by the conveyor in a contact state; a pressing member that pressurizes the recording medium against the heating member to fix the toner image held on the second face of the recording medium and contacts the toner image fixed onto the first face of the recording medium; and an irregular portion that is provided on a surface of the pressing member, has a plurality of protrusions and recesses, and has a difference in height between the recesses and the protrusions equal to or greater than a height of a toner layer in a solid toner image fixed onto the first face of the recording medium.

### BRIEF DESCRIPTION OF THE DRAWINGS

FIG. 1 is a schematic configuration diagram showing an example of an image forming apparatus including a fixing device according to a first embodiment.

FIG. 2 is a schematic configuration diagram of a toner image former of the image forming apparatus including the fixing device according to the first embodiment.

FIG. 3 is a configuration diagram of the fixing device according to the first embodiment.

FIG. 4 is a configuration diagram showing a part of a heater unit of the fixing device according to the first embodiment.

FIG. 5A is a diagram of a toner image fixed onto a first face of a sheet and a toner image held on a second face of the sheet, and FIG. 5B is an enlarged sectional view of a base material and a jacket of a pressure roll used in the fixing device according to the first embodiment.

FIG. 6 is an enlarged view of the jacket of the pressure roll used in the fixing device of the first embodiment.

FIG. 7 is an enlarged sectional view of a base material and a jacket of a pressure roll used in a fixing device according to a comparative example.

FIG. 8 is a graph showing measurement results of surface roughness of the jacket according to the first embodiment and the jacket according to the comparative example.

FIG. 9 is a diagram showing an example in which a measured sectional curve of the jacket according to the first embodiment is converted into an undulating curve.

### DETAILED DESCRIPTION

An example of an embodiment of the present invention will be described below with reference to the drawings. In each of the drawings, an arrow H indicates a vertical direction and an up-down direction of the apparatus, an arrow W indicates a horizontal direction and a width direction of the apparatus, and an arrow D indicates a front-rear direction of the apparatus (depth direction of the apparatus).

### First Embodiment

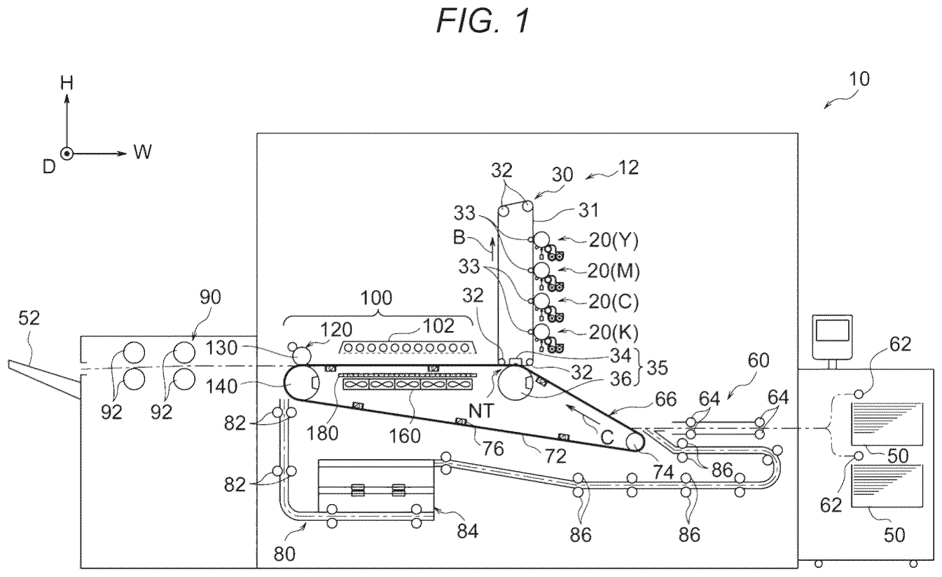

First, the configuration of an image forming apparatus 10 including a fixing device 100 according to a first embodiment will be described. FIG. 1 is a schematic diagram showing a configuration of an image forming apparatus 10 according to the first embodiment.

### (Image Forming Apparatus 10)

The image forming apparatus 10 shown in FIG. 1 is an example of an image forming system that forms an image on a recording medium. Specifically, the image forming apparatus 10 is an electrophotographic image forming apparatus that forms a toner image on a sheet P which is an example of a recording medium. More specifically, as shown in FIG. 1, the image forming apparatus 10 includes a storage 50, a discharger 52, an image forming unit 12, a conveyance mechanism 60, a reverse mechanism 80, the fixing device 100, and a cooler 90.

### (Storage 50)

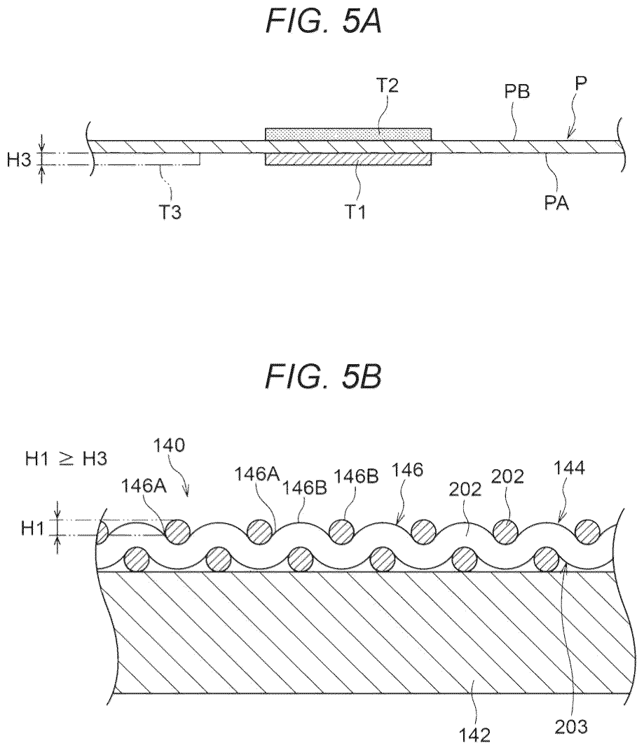

The storage 50 shown in FIG. 1 has a function of storing a sheet P. The image forming apparatus 10 is provided with a plurality of (for example, two) storages 50. The sheets P are selectively fed from the plurality of storages 50. A flat sheet (cut paper) having a predetermined size is used as the sheet P as an example of a recording medium. The sheet P has a first face PA (see FIG. 5) as one face and a second face PB (see FIG. 5) as the other face. In the first embodiment, the first face PA is a front surface of the sheet P, on which a toner image T1 is first held. The second face PB is a back surface of the sheet P, on which a toner image T2 is held after the toner image T1 on the first face PA is fixed.

### (Discharger 52)

The discharger 52 shown in FIG. 1 is a portion to which the sheet P on which an image is formed is discharged. Specifically, after the image is fixed by the fixing device 100, the sheet P cooled by the cooler 90 is discharged to the discharger 52.

### (Image Forming Unit 12)

The image forming unit 12 shown in FIG. 1 is an example of an image former that forms an image on a recording medium. Specifically, the image forming unit 12 has a function of forming a toner image on the sheet P by an electrophotographic method. More specifically, as shown in FIG. 1, the image forming unit 12 includes a toner image former 20 that forms a toner image, and a transfer device 30 that transfers the toner image formed by the toner image former 20 onto the sheet P.

### [Toner Image Former 20]

The plurality of toner image formers 20 are provided so as to form a toner image for each color. The image forming apparatus 10 includes toner image formers 20 for a total of four colors of yellow (Y), magenta (M), cyan (C), and black (K). (Y), (M), (C), and (K) shown in FIG. 1 indicate constituent portions corresponding to the respective colors.

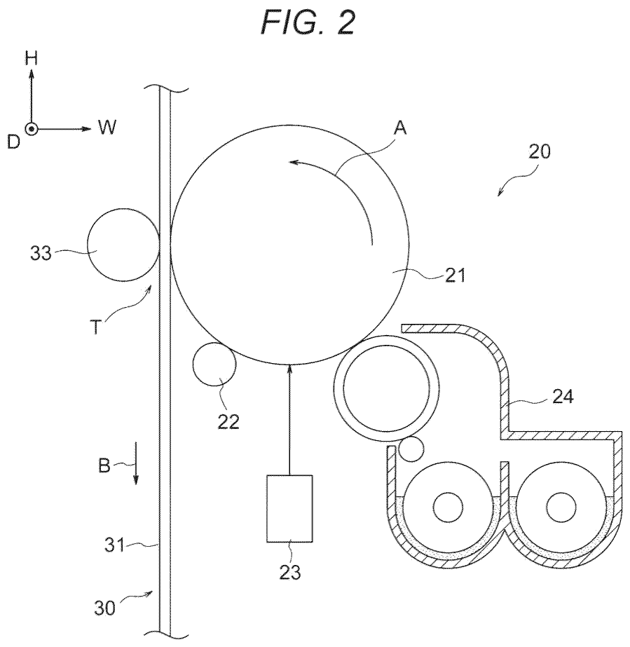

The toner image formers 20 of the respective colors are basically configured in a similar manner except for toners to be used. Specifically, as shown in FIG. 2, the toner image former 20 for each color includes a photosensitive drum 21 (photoreceptor) that rotates in the direction of an arrow A in FIG. 2, and a charger 22 that charges the photosensitive drum 21. The toner image former 20 for each color further includes an exposure device 23 that forms an electrostatic latent image on the photosensitive drum 21 by exposing the photosensitive drum 21 charged by the charger 22 to light, and a developing device 24 that forms a toner image by developing the electrostatic latent image formed on the photosensitive drum 21 by the exposure device 23.

### [Transfer Device 30]

The transfer device 30 shown in FIG. 1 has a function of primarily transferring a toner image of the photosensitive drum 21 of each color to an intermediate transfer body in a superimposed manner and secondarily transferring the superimposed toner images to the sheet P. Specifically, as shown in FIG. 1, the transfer device 30 includes a transfer belt 31 serving as an intermediate transfer body, a primary transfer roll 33, and a transferer 35.

The primary transfer roll 33 has a function of transferring the toner image formed on the photosensitive drum 21 to the transfer belt 31 at a primary transfer position T (see FIG. 2) between the photosensitive drum 21 and the primary transfer roll 33.

As shown in FIG. 1, the transfer belt 31 has an endless shape and is wound around a plurality of rolls 32 so that the orientation of the transfer belt 31 is determined. At least one of the plurality of rolls 32 is rotationally driven, and thus, the transfer belt 31 rotates in the direction of an arrow B and conveys the primarily transferred image to a secondary transfer position NT.

The transferer 35 has a function of transferring a toner image transferred to the transfer belt 31 onto the sheet P. Specifically, the transferer 35 includes a secondary transferer 34 and an opposing roll 36.

The opposing roll 36 is disposed below the transfer belt 31 so as to face the transfer belt 31. As shown in FIG. 1, the secondary transferer 34 is disposed inside the transfer belt 31 so that the transfer belt 31 is disposed between the secondary transferer 34 and the opposing roll 36. Specifically, the secondary transferer 34 includes a corotron. In the transferer 35, the toner image transferred to the transfer belt 31 is transferred to the sheet P passing through the secondary transfer position NT by an electrostatic force generated by discharge of the secondary transferer 34.

### (Conveyance Mechanism 60)

The conveyance mechanism 60 shown in FIG. 1 is a mechanism that conveys the sheet P. Specifically, the conveyance mechanism 60 has a function of conveying the sheet P stored in the storage 50 to the secondary transfer position NT. Furthermore, the conveyance mechanism 60 has a function of conveying the sheet P from the secondary transfer position NT to a fixing unit 120 described later (a heating roll 130 and a pressure roll 140 described later). In other words, the conveyance mechanism 60 has a function of conveying the sheet P to which the toner image has been transferred in the fixing device 100.

Specifically, as shown in FIG. 1, the conveyance mechanism 60 includes a feed roll 62, a plurality of conveyance rolls 64, and a chain gripper 66. The feed roll 62 is a roll that feeds the sheet P stored in the storage 50. The plurality of conveyance rolls 64 are rolls that convey the sheet P fed by the feed roll 62 to the chain gripper 66.

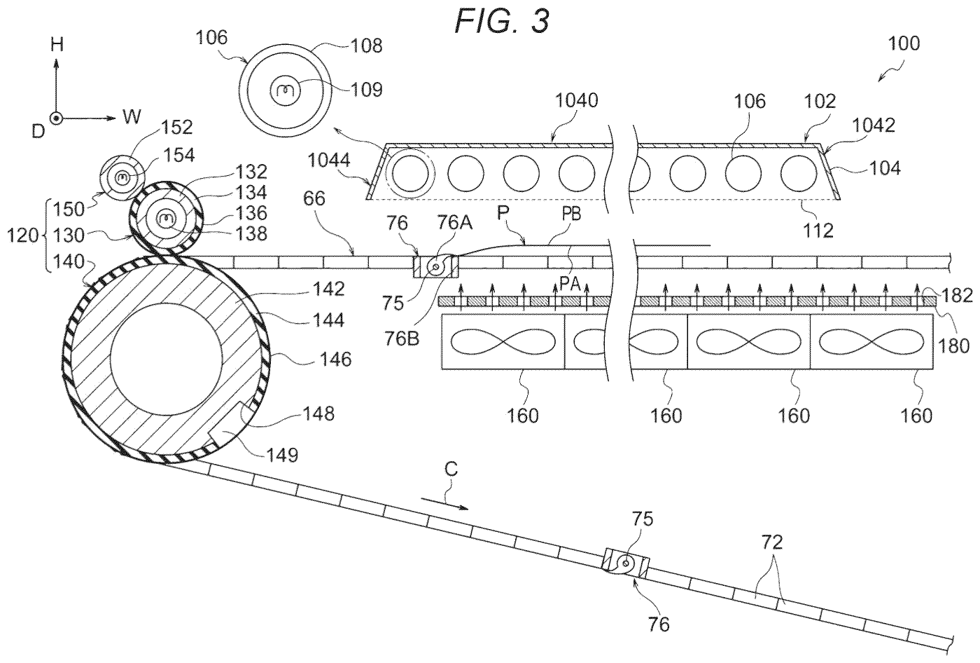

As shown in FIG. 3, the chain gripper 66 is an example of a conveyor that conveys the sheet P while holding a front end side (leading end side) of the sheet P. Specifically, the chain gripper 66 includes a pair of chains 72 and a gripper 76 as an example of a gripping portion (holder).

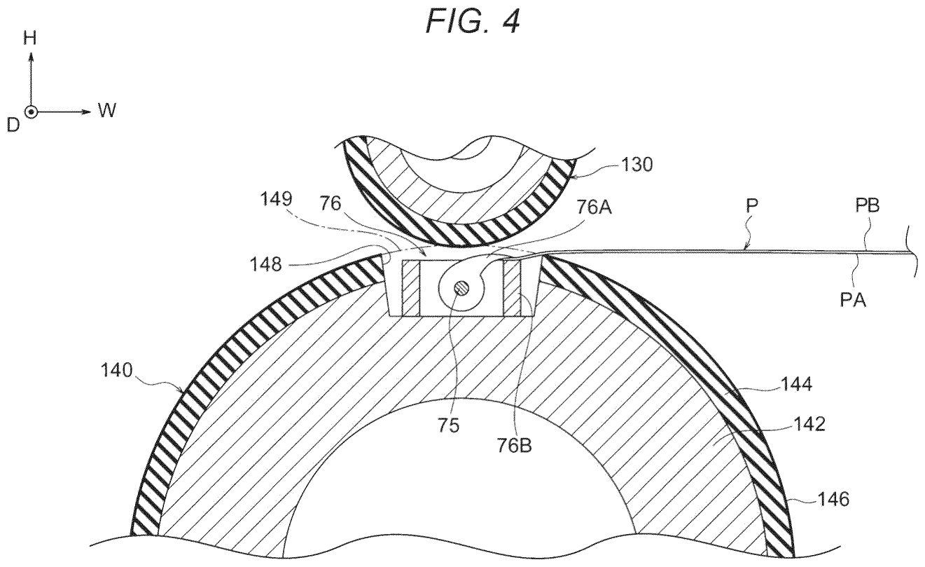

As shown in FIG. 1, the pair of chains 72 is formed in an annular shape. The pair of chains 72 is disposed at an interval in the front-rear direction of the apparatus (D direction in FIG. 1) (see FIG. 4). Then, the pair of chains 72 are respectively wound around a pair of sprockets (not shown) disposed on one end side and the other end side in an axial direction of each of the opposing roll 36 and the pressure roll 140 described later, and a pair of sprockets 74 disposed at an interval in the front-rear direction of the apparatus. When one of the pair of sprockets rotates, the chain 72 rotates in the direction of an arrow C (see FIG. 1).

An attachment member 75 (see FIG. 4) to which the gripper 76 is attached is bridged between the pair of chains 72 in the front-rear direction of the apparatus. The plurality of attachment members 75 are fixed to the pair of chains 72 at predetermined intervals along a peripheral direction (circulation direction) of the chains 72. In each drawing, in order to simplify the illustration of the chains 72, the component of each chain 72 is shown in a block shape.

The plurality of grippers 76 are attached to the attachment member 75 at predetermined intervals along the front-rear direction of the apparatus (see FIG. 3). The gripper 76 has a function of holding (gripping) the front end of the sheet P. By holding the front end of the sheet P, the position of the sheet P in a conveyance direction of the sheet is easily determined, and positioning (registration) of the sheet P and the image in the transferer 35 is easily performed. Specifically, as shown in FIGS. 3 and 4, the gripper 76 includes a claw 76A and a claw pad 76B. The gripper 76 is configured to hold the sheet P by pinching the front end of the sheet P between the claw 76A and the claw pad 76B. In the gripper 76, for example, the claw 76A is pressed against the claw pad 76B by a spring or the like, and the claw 76A is opened and closed with respect to the claw pad 76B by the action of a cam or the like.

Then, in the chain gripper 66, the chain 72 circulates in the direction of an arrow C in a state where the gripper 76 holds the front end of the sheet P, and the sheet P is conveyed. The chain gripper 66 conveys the sheet P to the secondary transfer position NT in a state where the first face PA faces upward, and further conveys the sheet P to the fixing unit 120 described later after causing the sheet P to pass through the heating portion 102 described later. In this manner, the chain gripper 66 is a portion having a function of holding the sheet P, causing the sheet P to pass through the heating portion 102, and conveying the sheet P from the heating portion 102 to the fixing unit 120, and also serves as the fixing device 100. A part of a conveyance path along which the sheet P is conveyed in the conveyance mechanism 60 is indicated by a one dot chain line in FIG. 1.

### (Reverse Mechanism 80)

The revere mechanism 80 shown in FIG. 1 is an example of a reverse mechanism that reverses the front and back of a recording medium on which an image is fixed by the fixing device 100. Specifically, the reverse mechanism 80 is a mechanism that reverses the front and back of the sheet P (that is, the first face PA and the second face PB of the sheet P) on which a toner image is fixed by the fixing device 100. More specifically, as shown in FIG. 1, the reverse mechanism 80 includes a plurality of (for example, two) conveyance rolls 82, a reverse device 84, and a plurality of (for example, seven) conveyance rolls 86.

The plurality of conveyance rolls 82 are rolls that convey the sheet P fed from the fixing device 100 to the reverse device 84.

As an example, the reverse device 84 is a device that reverses the front and back of the sheet P (that is, the first face PA and the second face PB of the sheet P) by twisting the sheet P like a Moebius strip by conveying the sheet P while curving the sheet P a plurality of times so that the conveyance direction of the sheet P changes by, for example, 90 degrees.

The plurality of conveyance rolls 86 are rolls that convey, to the chain gripper 66, the sheet P of which front and back (that is, the first face PA and the second face PB of the sheet P) are reversed by the reversing device 84. That is, the plurality of conveyance rolls 86 have a function of delivering the sheet P of which front and back (that is, the first face PA and the second face PB of the sheet P) are reversed to the chain gripper 66.

In this way, the reverse mechanism 80 reverses the front and back of the sheet P (that is, the first face PA and the second face PB of the sheet P) and delivers the sheet P to the chain gripper 66, and thus the chain gripper 66 conveys the delivered sheet P as the sheet P having the fixed toner image (image) T1 on the first face PA.

A part of a conveyance path along which the sheet P is conveyed in the reverse mechanism 80 is indicated by a chain line in FIG. 1. In addition, the reverse mechanism 80 may be a mechanism that reverses the sheet P by switching back the sheet P.

### (Fixing Device 100)

The fixing device 100 shown in FIG. 3 is an example of a fixing device that fixes an image formed by the image former onto a recording medium. Specifically, the fixing device 100 is a device that fixes the toner image transferred by the transfer device 30 to the sheet P.

As shown in FIG. 1, the fixing device 100 is disposed downstream of the secondary transfer position NT in the conveyance direction of the sheet P. As shown in FIG. 3, the fixing device 100 includes the heating portion 102, the chain gripper 66 described above, a blower 160, a ventilation plate 180, and the fixing unit 120 (fixing portion).

### [Heating Portion 102]

The heating portion 102 shown in FIG. 3 is an example of a non-contact heating portion that heats a front surface of the recording medium in a non-contact manner. Specifically, the heating portion 102 has a function of heating a face of the sheet P (for example, the second face PB in a case where the sheet P is reversed) facing the heating portion 102 in a non-contact manner, the sheet P being conveyed by the chain gripper 66. The face of the sheet P facing the heating portion 102 is the first face PA, or the second face PB when the sheet P is reversed as shown in FIG. 3.

The heating portion 102 is disposed downstream of the secondary transfer position NT (see FIG. 1) in the conveyance direction of the sheet P so as to face the first face PA of the sheet P conveyed by the chain gripper 66, or the second face PB when the sheet P is reversed as shown in FIG. 3. Specifically, the heating portion 102 includes a reflection plate 104, a plurality of heaters 106 (heating sources), and a wire mesh 112.

The reflection plate 104 has a function of reflecting infrared rays from the heater 106 to a lower side of the apparatus (toward the sheet P conveyed by the chain gripper 66). The reflection plate 104 is formed by using a metal plate such as an aluminum plate, for example. The reflection plate 104 has a shape of a box having the lower side of the apparatus is open. Specifically, the reflection plate 104 includes an upper reflection plate 1040 that covers an upper side of the heater 106 of the heating portion 102 in the apparatus, an upstream reflection plate 1042 that extends downward in the apparatus from the upper reflection plate 1040 upstream of the reflection plate 104 in the conveyance direction of the sheet P and covers an upstream surface of the heater 106, and a downstream reflection plate 1044 that extends downward in the apparatus from the upper reflection plate 1040 downstream of the reflection plate 104 in the conveyance direction of the sheet P and covers a downstream surface of the heater 106. Furthermore, although not shown, the reflecting plate 104 is constituted by a pair of side reflection plates that extend from the upper reflection plate 1040 to the lower side of the apparatus and cover both side surfaces of the heater 106 at both ends of the reflection plate 104 in a direction intersecting the conveyance direction of the sheet P.

The heater 106 is a columnar infrared heater having a length in the front-rear direction of the apparatus. The plurality of (for example, 40) heaters 106 are arranged along the width direction of the apparatus inside the reflection plate 104. The heater 106 includes, for example, a carbon filament 109 and a cylindrical quartz tube 108 that accommodates the carbon filament 109. A surface temperature of the heater 106 of the heating portion 102 is set to a predetermined temperature of, for example, 300° C. or more and 1175° C. or less.

The wire mesh 112 is fixed to an edge of an opening of a lower part of the reflection plate 104. Accordingly, the wire mesh 112 partitions the inside of the reflection plate 104 and the outside of the reflection plate 104. Then, the wire mesh 112 prevents the sheet P conveyed by the chain gripper 66 and the heater 106 from contacting each other.

As described above, the chain gripper 66 conveys the sheet P while causing the first face PA or the second face PB of the sheet P to face the heater 106 of the heating portion 102 by the chain 72 circulating in the direction of the arrow C in a state where the gripper 76 holds the front end of the sheet P. That is, the chain gripper 66 is an example of a conveyor that conveys the sheet P while causing the first face PA or the second face PB (see FIG. 3) of the sheet P to face the heating portion 102. A rear end of the sheet P is not held and is in a free state in the conveyance by the chain gripper 66.

Furthermore, the chain gripper 66 has a function of conveying the sheet P from the heating portion 102 to the fixing unit 120. As described above, the chain gripper 66 functions as an example of a conveyor of the fixing device 100 in a portion having a function of causing the sheet P to pass through a heating region of the heating portion 102 and conveying the sheet P from the heating portion 102 to the fixing unit 120.

### [Blower 160]

The blower 160 shown in FIG. 3 is an example of a blowing unit that blows air to a face opposite to the heating portion 102 (the second face PB, or the first face PA in a case where the sheet P is reversed as shown in FIG. 3) of the recording medium conveyed by the conveyor. The plurality of the blowers 160 are disposed on an inner side (inner peripheral side) of the chain 72 and below the heating portion 102 when viewed in the front-rear direction of the apparatus. As shown in FIG. 3, the plurality of blowers 160 are two dimensionally arranged (in a matrix) along the conveyance direction of the sheet P and the front-rear direction of the apparatus.

As shown in FIG. 3, the blower 160 faces upward and is configured to blow air upward. That is, the air is blown in a thickness direction of the sheet P only to a lower face (the second face PB, or the first face PA in a case where the sheet P is reversed as shown in FIG. 3) of the sheet P conveyed by the chain gripper 66 in a state where the lower face faces the heating portion 102.

As an example, an axial blower that blows air in the axial direction is used as the blower 160. As the blower 160, a centrifugal blower that blows air in a centrifugal direction, such as a multi-blade blower (for example, a sirocco fan), may be used.

The blower 160 blows air toward a lower face (for example, the first face PA shown in FIG. 3) of the sheet P conveyed by the chain gripper 66, and thus, the sheet P is lifted. Accordingly, the lower face (for example, the first face PA) of the sheet P is in a non-contact state. Therefore, the blower 160 has a function of maintaining the non-contact state so that the sheet P is conveyed by the chain gripper 66 in a state where the lower face (for example, the first face PA) of the sheet P is in a non-contact state. The blower 160 supplies air only to the lower face (for example, the first face PA) of the sheet P, and thus, cooling of the toner transferred to an upper face (for example, the second face PB shown in FIG. 3) of the sheet P is suppressed.

### [Ventilation Plate 180]

The ventilation plate 180 shown in FIG. 3 is an example of a ventilator having a plurality of ventilation holes through which air blown from the blowing unit toward a back surface of the recording medium passes. Specifically, the ventilation plate 180 includes a plate provided with a plurality of ventilation holes 182 through which air blown from the blower 160 toward the lower face (for example, the first face PA) of the sheet P passes.

The ventilation plate 180 is disposed with its thickness direction parallel to the up-down direction of the apparatus, in the inner side (inner peripheral side) of the chain 72 as viewed in the front-rear direction of the apparatus, below the heating portion 102 and above the blower 160. That is, the ventilation plate 180 is disposed so as to cover the air blower 160 on a blowing direction side of the air blower 160.

Each of the ventilation holes 182 penetrates the ventilation plate 180 in the thickness direction. The plurality of ventilation holes 182 are two dimensionally arranged (in a matrix) along, for example, the conveyance direction of the sheet P and the front-rear direction of the apparatus.

In the ventilation plate 180, air blown from the blower 160 passes through the plurality of ventilation holes 182 and hits the lower face (for example, the first face PA) of the sheet P conveyed by the chain gripper 66.

### [Fixing Unit 120]

The fixing unit 120 shown in FIG. 3 is a fixing portion that fixes an image on the sheet P to the sheet P. Specifically, the fixing unit 120 has a function of contacting the sheet P and heating and pressurizing the sheet P to fix a toner image onto the sheet P.

As shown in FIG. 3, the fixing unit 120 is disposed downstream of the heating portion 102 in the conveyance direction of the sheet P. Specifically, the fixing unit 120 includes the heating roll 130, the pressure roll 140, and a driven roll 150.

### [Heating Roll 130]

The heating roll 130 shown in FIG. 3 is an example of a heating member that heats a toner image held on the sheet P in a contact state. Specifically, the heating roll 130 is disposed downstream of the heating portion 102 in the conveyance direction, and has a function of contacting the sheet P and heating the sheet P. The heating roll 130 is disposed with its axial direction parallel to the front-rear direction of the apparatus so as to be in contact with the upper face of the sheet P (the first face PA, or the second face PB when the sheet P is reversed as shown in FIG. 3). In FIG. 3, the heating roll 130 heats the toner image held on the second face PB of the sheet P in a contact state.

The heating roll 130 includes a cylindrical base material 132, a rubber layer 134 formed on an outer periphery of the base material 132, a release layer 136 formed on an outer periphery of the rubber layer 134, and a heater 138 (heating source) accommodated in the base material 132. The heater 138 includes, for example, a single halogen lamp or a plurality of halogen lamps.

### [Driven Roll 150]

The driven roll 150 shown in FIG. 3 is disposed with its axial direction parallel to the front-rear direction of the apparatus so as to be in contact with a region other than a contact region with the sheet P on an outer peripheral surface of the heating roll 130. The driven roll 150 includes a cylindrical base material 152 and a heater 154 (heating source) accommodated in the base material 152. The driven roll 150 is rotated by the heating roll 130, and heats the heating roll 130. Since the heating roll 130 is heated by the driven roll 150 and the heating roll 130 itself has the heater 138, a surface temperature of the heating roll 130 is a predetermined temperature of 180° C. or more and 200° C. or less.

### [Pressure Roll 140]

The pressure roll 140 shown in FIG. 3 is an example of a pressing member that pressurizes the recording medium against the heating roll 130. Specifically, the pressure roll 140 has a function of interposing the sheet P between the pressure roll 140 and the heating roll 130 and pressurizing the sheet P. The pressure roll 140 is disposed with its axial direction parallel to the front-rear direction of the apparatus, below the heating roll 130.

A peripheral length of the pressure roll 140 is the same as the arrangement interval at which the gripper 76 as an example of a gripping portion is arranged on the chain 72. As shown in FIG. 4, a dent 148 extending in the front-rear direction of the apparatus is formed in an outer peripheral surface of the pressure roll 140. When the gripper 76 that holds the front end side of the sheet P passes between the pressure roll 140 and the heating roll 130, the gripper 76 enters the dent 148. The pressure roll 140 is an example of a pressure cylinder having the dent 148 formed on a front surface side.

The pressure roll 140 includes a cylindrical base material 142 and a jacket 144 attached to an outer periphery of the base material 142.

As shown in FIG. 4, in the first embodiment, the dent 148 is formed on a surface of the base material 142, and the jacket 144 is attached to the surface of the base material 142 except for the dent 148. Although not shown, support pieces extend from both ends of the jacket 144 in a width direction (that is, both ends in the front-rear direction of the apparatus). The supporting pieces of the jacket 144 are brought into contact with both ends of the base material 142 in the axial direction, and the supporting pieces are fixed to the base material 142 by an attachment tool, so that the jacket 144 is attached to the base material 142. As an example, the base material 142 includes metal.

Here, an example will be described in which an image is formed on the first face PA of the sheet P, and thereafter, an image is formed on the second face PB of the sheet P in duplex printing. In this example, the pressure roll 140 pressurizes the sheet P against the heating roll 130, fixes the toner image T2 (see FIG. 5A) held on the second face PB of the sheet P, and contacts the toner image T1 (see FIG. 5B) fixed onto the first face PA of the sheet P. Specifically, the toner image T1 fixed onto the first face PA of the sheet P contacts the jacket 144 of the pressure roll 140.

As shown in FIG. 5B, an irregular portion 146 having a plurality of recesses and protrusions is formed on the surface of the jacket 144. Specifically, the irregular portion 146 includes a plurality of recesses 146A and a plurality of protrusions 146B. A difference H1 in height between the recesses and the protrusions of the irregular portion 146 (that is, a peak-to-peak value of the recesses and protrusions) is equal to or greater than a height H3 of a toner layer of a solid toner image T3 fixed onto the first face PA of the sheet P. Here, the solid toner image T3 is a toner image having a toner density of 100% in a fixed image on the sheet P.

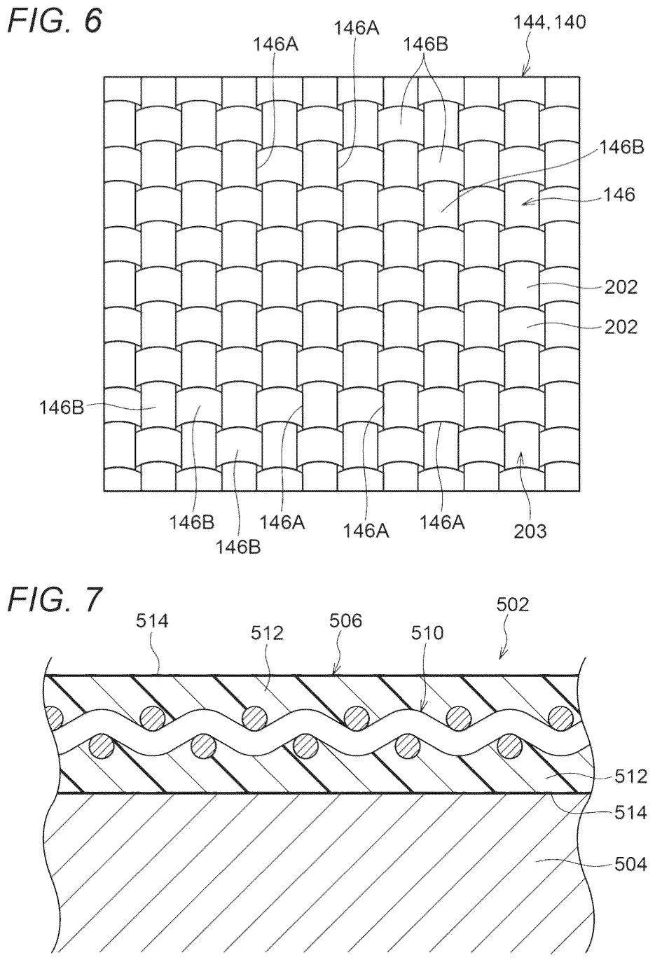

As shown in FIG. 6, the jacket 144 includes, for example, a woven member 203 as an example of a woven portion in which a fiber 202 are woven. Accordingly, the irregular portion 146 is formed by a surface of the woven member 203 in which the fiber 202 is woven. As an example, the fiber 202 is a glass fiber. As an example, the glass fiber is a glass fiber impregnated with a release agent.

The jacket 144 may include, for example, a member in which the fiber 202 is woven, and the irregular portion 146 may be formed by a woven portion in which the fiber 202 is woven.

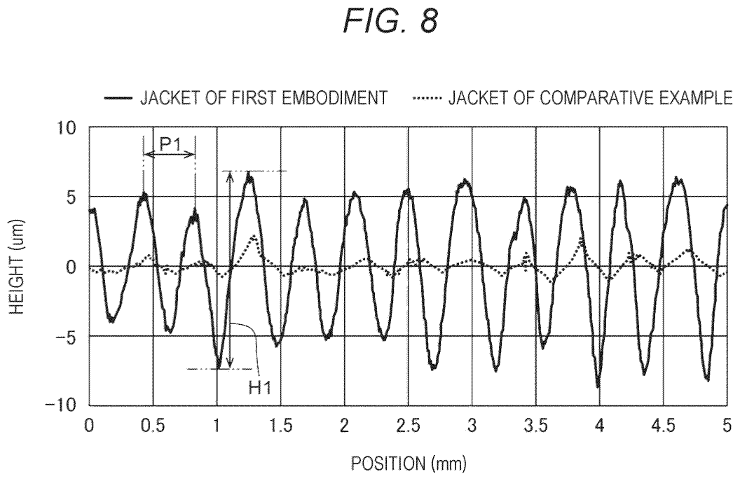

FIG. 8 shows a result of measurement of a surface roughness of the irregular portion 146 on the surface of the jacket 144. The surface roughness of the irregular portion 146 is a value measured by a surface roughness measurer (Surfcom, manufactured by TOKYO SEIMITSU CO., LTD.) described later.

As shown in FIG. 8, a pitch P1 of a weave of the jacket 144 (that is, a pitch of the protrusion 146B) is preferably 0.8 mm or less, more preferably 0.7 mm or less, and still more preferably 0.6 mm or less. The pitch P1 of the stitch (or weave) of the jacket 144 is equivalent to a pitch of the protrusion 146B of the irregular portion 146 of the jacket 144. If the pitch P1 of the weave of the jacket 144 is greater than 0.8 mm, melting unevenness of the toner image T1 on the first face PA of the sheet P is likely to occur. If the pitch P1 of the weave of the jacket 144 is greater than 0.8 mm, the sheet P, which is a coated paper having a basis weight of 64 gsm, is likely to be deformed.

As shown in FIG. 8, the peak-to-peak value of the recesses and protrusions of the irregular portion 146, that is, the difference H1 in height between the recesses and the protrusions is preferably 8 μm or more and 20 μm or less, more preferably 9 μm or more and 18μm or less, and still more preferably 10 μm or more and 16 μm or less.

Here, the peak-to-peak value of the recesses and protrusions of the irregular portion 146, that is, the difference H1 in height between the recesses and the protrusions can be indicated by the maximum height roughness Rz. In other words, the maximum height roughness Rz is a surface roughness corresponding to the difference H1 in height of the recesses and the protrusions. The maximum height roughness Rz is measured as follows.

The outer peripheral surface of the pressure roll is scanned in the axial direction in a region from one edge in the axial direction to a position of 5 mm toward a center to measure a surface shape (roughness curve). The scanning in the axial direction is performed every 10° in a peripheral direction a total of 36 times.

The measurement is performed by using a surface roughness measurer (Surfcom, manufactured by TOKYO SEIMITSU CO., LTD.) under the conditions of a measurement length of 2.5 mm, a cutoff wave length of 0.8 mm, and a measurement speed of 0.60 mm/s.

The maximum height roughness Rz is calculated on the basis of the roughness curve obtained by the scanning.

The maximum height roughness Rz is calculated by obtaining a “sum of a maximum value of a peak height and a maximum value of a valley depth” from the roughness curve. In other words, when the highest portion in a reference length is set as a maximum peak height Zp and the lowest portion is set as a maximum valley depth Zv, the difference therebetween is the maximum height roughness Rz (=Zp−Zv).

The value, 20 μm, which is an upper limit of the difference H1 in height between the recesses and the protrusions of the irregular portion 146 (that is, the maximum height roughness Rz corresponding to the difference H1 in height between the recesses and the protrusions), is a value defined by a height of the fixed image. If the difference H1 in height between the recesses and the protrusions of the irregular portion 146 is greater than 20 μm, the sheet P is likely to be deformed. For example, if the difference H1 in height between the recesses and the protrusions of the irregular portion 146 is greater than 20 μm, the sheet P, which is coated paper having a basis weight of 64 gsm, is likely to be deformed.

An arithmetic average waviness Wa of the irregular portion 146 is preferably 2 μm or more and 5 μm or less, more preferably 2.5 μm or more and 4.5 μm or less, and still more preferably 3 μm or more and 4 μm or less. If the arithmetic average waviness Wa of the irregular portion 146 is greater than 5 μm, the sheet P, which is a thin film having a thickness of 100 μm, is likely to be conspicuously changed in shape. The arithmetic average waviness Wa is obtained by extracting a part of a roughness curve measured by a surface roughness measurer described later with a reference length and expressing an irregular state of the section as an average value.

Here, the arithmetic average waviness Wa is an average of absolute values of heights of undulating curves in the reference length specified in JIS B0601 (2013), and is a value measured by the surface roughness measurer (Surfcom, manufactured by TOKYO SEIMITSU CO., LTD.). The arithmetic average waviness Wa is measured as follows.

The outer peripheral surface of the pressure roll is scanned from one end to the other end in the axial direction to measure a surface shape (sectional curve). The scanning in the axial direction is performed every 10° in a peripheral direction a total of 36 times.

The measurement is performed by using a surface roughness measurer (Surfcom, manufactured by TOKYO SEIMITSU CO., LTD.) under the conditions of a measurement length of 4 mm, a cutoff wave length λc of 0.8 mm, and a measurement speed of 0.60 mm/s.

The arithmetic average waviness Wa is calculated on the basis of a measured sectional curve obtained by the scanning.

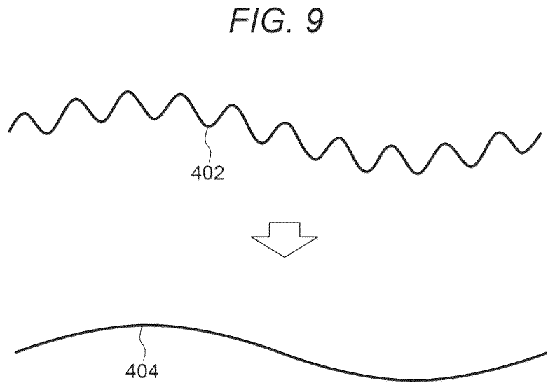

As shown in FIG. 9, an undulating curve 404 is obtained by removing a shape of a short wavelength from a measured sectional curve 402 measured by the surface roughness measurer (Surfcom, manufactured by TOKYO SEIMITSU CO., LTD.), and how much short wavelength is removed is determined by a cutoff wavelength λc. For example, if λc is 0.8 mm, shapes with wavelengths shorter than 0.8 mm are ignored.

Since the jacket 144 is attached to the surface of the base material 142 except for the dent 148 as described above, the irregular portion 146 is provided on the surface of the pressure roll 140 excluding the dent 148.

In the fixing unit 120, the pressure roll 140 is rotationally driven by a drive unit (not shown), the heating roll 130 is rotated by the pressure roll 140, and the driven roll 150 is rotated by the heating roll 130.

### (Cooler 90)

As shown in FIG. 1, the cooler 90 is disposed downstream of the fixing unit 120 in the conveyance direction of the sheet P. In addition, the cooler 90 includes a plurality of (for example, two) cooling rolls 92 arranged in the width direction of the apparatus.

The cooling roll 92 is a cylindrical roll including metal or the like. The cooling roll 92 is configured to cool the sheet P by air cooling (heat exchange with air) by air flowing inside the cooling roll 92.

### (Operation of Image Forming Apparatus)

Next, an operation of the image forming apparatus 10 will be described.

The sheet P fed from the storage 50 shown in FIG. 1 is conveyed by the plurality of conveyance rolls 64 and is delivered to the chain gripper 66. The sheet P delivered to the chain gripper 66 is conveyed to the secondary transfer position NT by the chain gripper 66 in a state where the front end is held by the gripper 76, and the toner image is transferred from the transfer belt 31 to the first face PA. As shown in FIG. 3, the sheet P to which the toner image is transferred is conveyed by the chain gripper 66 in a state where the first face PA faces the heater 106 of the heating portion 102, and the toner image is heated.

The sheet P on which the toner image has been heated by the heating portion 102 is further conveyed to the fixing unit 120 by the chain gripper 66, is interposed between the heating roll 130 and the pressure roll 140, and is pressurized and heated. As a result, the toner image is fixed onto the first face PA of the sheet P. When an image is to be formed only on the first face PA of the sheet P, the sheet P on which the toner image is fixed is cooled by the cooling roll 92 of the cooler 90 and is then discharged to the discharger 52.

When images are to be formed on both faces of the sheet P (that is, duplex printing), the sheet P in which the image is fixed onto the first face PA is reversed between the first face PA and the second face PB by the reverse mechanism 80 shown in FIG. 1, and is then delivered to the chain gripper 66 again. The sheet P delivered to the chain gripper 66 is conveyed to the secondary transfer position NT as the sheet P having the fixed toner image (image) T1 on the first face PA, and the toner image T2 is transferred from the transfer belt 31 to the second face PB (see FIG. 5A). The chain gripper 66 conveys, to the fixing device 100, the sheet P in which the toner image T1 is fixed onto the first face PA by heating and pressurizing and the unfixed toner image T2 is transferred (that is, held) to the second face PB.

As described above, after being heated by the heating portion 102, the sheet P having the second face PB onto which the toner image T2 is transferred is interposed between the heating roll 130 and the pressure roll 140, and is pressurized and heated, and thus, the toner image T2 is fixed onto the sheet P. At this time, in the heating portion 102, the blower 160 blows air to the first face PA of the sheet P conveyed by the chain gripper 66, and thus the blower 160 is maintained in a non-contact state so that the sheet P is conveyed with the first face PA of the sheet P in the non-contact state.

The sheet P on which the toner image T2 is fixed is cooled by the cooling roll 92 of the cooler 90 and is then discharged to the discharger 52.

### (Fixing Device According to Comparative Example)

Next, before specifically describing an action of the first embodiment, a fixing device according to a comparative example will be described.

FIG. 7 is an enlarged sectional view showing a fixing roll 502 used in the fixing device according to the comparative example. As shown in FIG. 7, the fixing roll 502 includes a base material 504 and a jacket 506 attached to an outer periphery of the base material 504. The jacket 506 is attached to the base material 504 by an attachment tool (not shown).

The jacket 506 includes a woven portion 510 in which the fiber 202 is woven, resin layers 512 formed on both sides of the woven portion 510 in a thickness direction, and coating layers 514 coating surfaces of the resin layers 512. The resin layer 512 includes, for example, a fluororesin. The coating layer 514 is formed by coating the surface of the resin layer 512 with a film having releasability, such as polytetrafluoroethylene, for example.

The surface of the coating layer 514 of the jacket 506 is smoother than the surface of the woven portion 510. FIG. 8 shows a measurement result of a surface roughness of the jacket 506. As shown in FIG. 8, a difference in height of recesses and protrusions (that is, peak-to-peak value) of the coating layer 514 of the jacket 506 is, for example, 3.5 μm or less. Other configurations of the fixing device according to the comparative example are similar to the configuration of the fixing device 100 according to the first embodiment.

In the fixing device according to the comparative example, after the toner image T1 on the first face PA of the sheet P is fixed by heating and pressurizing in duplex printing, the toner image T2 on the second face PB of the sheet P is fixed. When the toner image T2 on the second face PB of the sheet P is fixed, the toner image T1 on the first face PA of the sheet P is heated to a high temperature and slightly melted by the heating portion 102 (see FIG. 1). Furthermore, when the toner image T2 on the second face PB of the sheet P is fixed by the fixing unit 120 (see FIG. 1) downstream of the heating portion 102 in the conveyance direction, the toner image T1 on the first face PA of the sheet P is in contact with the fixing roll 502. When the sheet P passes between the fixing roll 502 and the heating roll 130 (see FIG. 1) in this state, the toner image T1 on the first face PA of the sheet P is likely to be melt and become uneven. This may cause gloss unevenness of the image due to melting of the toner on the first face PA of the sheet P. Here, the gloss unevenness of the image due to the melting of the toner on the first face PA of the sheet P refers to unevenness in gloss between the first face PA and the second face PB of one sheet P. The gloss refers to glossiness.

### (Action of First Embodiment)

Next, the action of the first embodiment will be described.

As shown in FIG. 5A, in the fixing device 100, after the toner image TI on the first face PA of the sheet P is fixed by heating and pressurizing in the duplex printing, the toner image T2 on the second face PB of the sheet P is fixed. The fixing device 100 conveys, by the chain gripper 66, the sheet P in which the toner image is fixed onto the first face PA by heating and pressurizing and the unfixed toner image is held on the second face PB.

In the fixing device 100, the heating roll 130 heats the toner image T2 held on the second face PB of the sheet P in a contact state. The sheet P is further pressurized between the heating roll 130 and the pressure roll 140, and thus, the toner image T2 held on the second face PB of the sheet P is fixed. At this time, the pressure roll 140 contacts the toner image T1 fixed onto the first face PA of the sheet P, and passes between the heating roll 130 and the pressure roll 140.

In the fixing device 100, the surface of the pressure roll 140 is provided with the irregular portion 146 having a plurality of recesses and protrusions. The difference H1 in height between the recesses and the protrusions of the irregular portion 146 is equal to or greater than the height H3 of the toner layer of the solid toner image T3 fixed onto the first face PA of the sheet P.

Accordingly, even if the toner image T1 on the first face PA of the sheet P contacts the pressure roll 140, a heat conductivity can be reduced by reducing a contact area of the toner image T1 on the first face PA of the sheet P and the pressure roll 140. Therefore, the toner image T1 on the first face PA of the sheet P is prevented from being melted.

As a result, in the fixing device 100, when the toner image T2 on the second face PB of the sheet P is fixed after the toner image T1 on the first face PA of the sheet P is fixed, gloss unevenness of the image due to melting of the toner on the first face PA of the sheet P can be suppressed more than in a case where the surface of the pressure roll is smooth.

In the fixing device 100, the heating portion 102 that heats the toner image on the second face PB of the sheet P in a non-contact state is provided upstream of the heating roll 130 in the conveyance direction of the sheet P. The fixing device 100 further includes the chain gripper 66 that conveys the sheet P between the heating roll 130 and the pressure roll 140 while causing the second face PB of the sheet P to face the heating portion 102. Therefore, in the fixing device 100, in a configuration in which the toner image T2 on the second face PB of the sheet P is heated in a non-contact state upstream of the heating roller 130, the gloss unevenness of the image due to the melting of the toner on the first face PA of the sheet P can be also suppressed.

In the fixing device 100, the maximum height roughness Rz corresponding to the difference H1 in height between the recesses and the protrusions of the irregular portion 146 in the pressure roll 140 is 8 μm or more and 20 μm or less. Therefore, in the fixing device 100, the gloss unevenness of the image due to the melting of the toner on the first face PA of the sheet P can be suppressed more than in a case where the maximum height roughness Rz corresponding to the difference H1 in height between the recesses and the protrusions is less than 8 μm. In addition, deformation of the sheet P can be suppressed more than in a case where the maximum height roughness Rz corresponding to the difference H1 in height between the recesses and the protrusions of the irregular portion is greater than 20 μm.

In the fixing device 100, the arithmetic average waviness Wa of the irregular portion 146 of the pressure roll 140 is 2 μm or more and 5 μm or less. Therefore, in the fixing device 100, the gloss unevenness of the image due to the melting of the toner on the first face PA of the sheet P can be suppressed more than in a case where the arithmetic average waviness Wa of the irregular portion 146 is less than 2 μm. In addition, the deformation of the sheet P can be suppressed more than in a case where the arithmetic average waviness Wa of the irregular portion 146 is greater than 5 μm.

In the fixing device 100, the irregular portion 146 is formed by the woven member 203 in which the fiber 202 is woven, and the pressure roll 140 has the woven member 203 attached to a peripheral surface of the metal base material 142. Therefore, in the fixing device 100, the difference H1 in height between the recesses and the protrusions of the irregular portion 146 is set as intended more easily than in a case where the irregular portion is directly formed on the surface of the pressure roll.

In the fixing device 100, the fiber 202 is a glass fiber. Therefore, in the fixing device 100, the toner on the first face PA of the sheet P is less likely to adhere to the pressure roller 140 than in a case where the fiber includes resin.

In the fixing device 100, the glass fiber is a glass fiber impregnated with a release agent. Therefore, in the fixing device 100, the toner on the first face PA of the sheet P is less likely to adhere to the pressure roll 140 than in a case where a glass fiber that are not impregnated with resin is woven.

In the fixing device 100, the pressure roll 140 is a pressure cylinder in which the dent 148 into which the gripper 76 gripping the front end of the sheet P enters is formed on the surface side, and the irregular portion 146 is provided on the surface of the pressure cylinder except for the dent 148. Therefore, in the fixing device 100, in a case where the pressure roll 140 is a pressure cylinder in which the dent 148 into which the gripper 76 gripping the front end of the sheet P enters is formed, it is possible to suppress the gloss unevenness of an image due to melting of the toner on the first face PA of the sheet P.

The image forming apparatus 10 further includes an image forming unit 12 that forms a toner image on the sheet P and the fixing device 100 that fixes the toner image T1 formed on the first face PA of the sheet P by the image forming unit 12 to the sheet P and fixes the toner image formed on the second face PB of the sheet P by the image forming unit 12 onto the sheet P. The image forming apparatus 10 further includes a reverse mechanism that reverses the sheet P from the first face PA to the second face PB after the toner image T1 is fixed on the first face PA of the sheet P by the fixing device 100. Therefore, in the image forming apparatus 10, when the toner image T2 on the second face PB of the sheet P is fixed after the toner image T1 on the first face PA of the sheet P is fixed, the gloss unevenness of the image due to melting of the toner on the first face PA of the sheet P can be suppressed more than in a case where the surface of the pressure roll is smooth.

### <First Modification>

In the fixing device 100 according to the first embodiment, the jacket 144 is attached to the surface of the base material 142 of the pressure roll 140, but the present disclosure is not limited to this configuration.

In the fixing device of the first modification, although not shown, the irregular portion 146 may be formed by directly processing the surface of the pressure roll. For example, the surface of the pressure roll may include a resin layer, and the irregular portion 146 may be configured by directly processing the surface of the resin layer. This configuration can save more material cost than in a case where a cover member is attached to the peripheral surface of the base material of the pressure roll.

### <Second Modification>

The image forming apparatus 10 according to the first embodiment includes the reverse mechanism 80 that reverses the sheet P from the first face PA to the second face PB after the toner image T1 is fixed onto the first face PA of the sheet P by the fixing device 100, but the present disclosure is not limited to this configuration.

The image forming apparatus of the second modification is not required to include the reverse mechanism 80 shown in FIG. 1. Specifically, the image forming apparatus includes the image forming unit 12 that forms a toner image on the sheet P and the fixing device 100 that fixes the toner image formed by the image forming unit 12 onto the sheet P, and is not provided with a reverse mechanism that reverses the sheet P.

In the image forming apparatus, after the toner image T1 is fixed onto the first face PA of the sheet P by the fixing device 100, the sheet P is discharged to the discharger. Accordingly, the sheet P is stacked on the discharger in the up-down direction with the first face PA of the sheet P facing upward. Thereafter, the stacked sheet P is turned upside down by an external reverse device (not shown) or manually, and thus, the sheet P is stacked with the second face PB facing upward. Then, in the image forming apparatus, the sheet P with the second face PB facing upward is stored in the storage 50, the toner image T2 is formed on the second face PB of the sheet P, and the toner image T2 on the second face PB of the sheet P is fixed by the fixing device 100.

In the image forming apparatus of the second modification, when the toner image T2 on the second face PB of the sheet P is fixed after the toner image T1 on the first face PA of the sheet P is fixed, the gloss unevenness of an image due to melting of toner on the first face PA of the sheet P can be suppressed more than in a case where the surface of the pressure roll is smooth.

### <Other Modifications>

Although the sheet P is used as an example of a recording medium in the embodiment, the present disclosure is not limited thereto. For example, a film may be used as an example of the recording medium, and a sheet material having a sheet shape (paper shape or film shape) other than the sheet P may be used as an example of the recording medium.

In the embodiment, the chain gripper 66 as an example of a conveyor conveys the sheet P to the secondary transfer position NT, causes the sheet P to pass through the heating portion 102, and then conveys the sheet P to the fixing unit 120. However, the present disclosure is not limited thereto. An example of the conveyor may be a conveyor such as a chain gripper that delivers the sheet P passing through the secondary transfer position NT, causes the sheet P to pass through the heating portion 102, and then conveys the sheet P to the fixing unit 120. In this case, the sheet is conveyed to the secondary transfer position NT by another conveyor (for example, a conveyance roll).

Although the jacket 144 includes the woven member 203 in which the fiber 202 is woven in the embodiment, the present disclosure is not limited to this configuration. For example, a resin sheet on which the irregular portion 146 is formed may be attached to a base material.

When the woven member 203 in which the fiber 202 is woven is used, the fiber 202 may be a resin other than a glass fiber. For example, a woven portion in which a fiber including a fluororesin having releasability is woven may be used.

Although a specific embodiment of the present disclosure has been described in detail, the present disclosure is not limited to the embodiment, and it will be apparent to those skilled in the art that various other embodiments are possible within the scope of the present disclosure.

### <Preferred Aspects of Present Disclosure>

Hereinafter, preferred aspects of the present disclosure will be additionally described.

(((1)))

A fixing device comprising:

a conveyor that conveys a recording medium in which a toner image is fixed onto a first face by heating and pressurizing and a toner image unfixed is held on a second face;

a heating member that heats the toner image held on the second face of the recording medium conveyed by the conveyor in a contact state;

a pressing member that pressurizes the recording medium against the heating member to fix the toner image held on the second face of the recording medium and contacts the toner image fixed onto the first face of the recording medium; and

an irregular portion that is provided on a surface of the pressing member, has a plurality of protrusions and recesses, and has a difference in height between the recesses and the protrusions equal to or greater than a height of a toner layer in a solid toner image fixed onto the first face of the recording medium.

(((2)))

The fixing device according to (((1))) further comprising a non-contact heating portion provided upstream of the heating member in a conveyance direction of the recording medium and heats the toner image on the second face of the recording medium in a non-contact state, wherein

the conveyor conveys the recording medium between the heating member and the pressing member while causing the second face of the recording medium to face the non-contact heating portion.

(((3)))

The fixing device according to (((1))) or (((2))), wherein

a maximum height roughness Rz corresponding to the difference in height between the recesses and the protrusions is 8 μm or more and 20 μm or less.

(((4)))

The fixing device according to any one of (((1))) to (((3))), wherein

the irregular portion has an arithmetic average waviness Wa of 2 mm or more and 5 mm or less.

(((5)))

The fixing device according to any one of (((1))) to (4))), wherein

the irregular portion includes a woven portion formed by weaving a fiber, and

the pressing member has the woven portion attached to a peripheral surface of a base material including metal.

(((6)))

The fixing device according to (((5))), wherein

the fiber is a glass fiber.

(((7)))

The fixing device according to (((6))), wherein

the glass fiber is a glass fiber impregnated with a release agent.

(((8)))

The fixing device according to any one of (((1))) to (((4))), wherein

the irregular portion is configured by directly processing the surface of the pressing member.

(((9)))

The fixing device according to (((1))) to (((8))), wherein

the pressing member is a pressure cylinder in which a dent into which a gripping portion that grips a front end side of the recording medium enters is formed on a surface side, and

the irregular portion is provided on the surface of the pressure cylinder except for the dent.

(((10)))

An image forming system comprising:

an image former that forms a toner image on a recording medium; and

the fixing device according to any one of (((1))) to (((9))), the fixing device fixing the toner image formed by the image former onto the recording medium.

(((11)))

An image forming system comprising:

an image former that forms a toner image on a recording medium;

the fixing device according to any one of (((1))) to (((9))), the fixing device fixing the toner image formed on the first face of the recording medium by the image former onto the recording medium and fixing the toner image formed on the second face of the recording medium by the image former onto the recording medium; and

a reverse mechanism that reverses the recording medium from the first face to the second face after the toner image is fixed onto the first face of the recording medium by the fixing device.

What is claimed is:

1. A fixing device comprising:
a conveyor that conveys a recording medium in which a toner image is fixed onto a first face by heating and pressurizing and a toner image unfixed is held on a second face;
a heating member that heats the toner image held on the second face of the recording medium conveyed by the conveyor in a contact state;
a pressing member that pressurizes the recording medium against the heating member to fix the toner image held on the second face of the recording medium and contacts the toner image fixed onto the first face of the recording medium; and
an irregular portion that is provided on a surface of the pressing member, has a plurality of protrusions and recesses, and has a difference in height between the recesses and the protrusions equal to or greater than a height of a toner layer in a solid toner image fixed onto the first face of the recording medium.

2. The fixing device according to claim 1, further comprising a non-contact heating portion provided upstream of the heating member in a conveyance direction of the recording medium and heats the toner image on the second face of the recording medium in a non-contact state, wherein
the conveyor conveys the recording medium between the heating member and the pressing member while causing the second face of the recording medium to face the non-contact heating portion.

3. The fixing device according to claim 1, wherein
a maximum height roughness Rz corresponding to the difference in height between the recesses and the protrusions is 8 μm or more and 20 μm or less.

4. The fixing device according to claim 3, wherein the irregular portion has an arithmetic average waviness Wa of 2 mm or more and 5 mm or less.

5. The fixing device according to claim 1, wherein
the irregular portion includes a woven portion formed by weaving a fiber, and
the pressing member has the woven portion attached to a peripheral surface of a base material including metal.

6. The fixing device according to claim 5, wherein
the fiber is a glass fiber.

7. The fixing device according to claim 6, wherein
the glass fiber is a glass fiber impregnated with a release agent.

8. The fixing device according to claim 1, wherein
the irregular portion is configured by directly processing the surface of the pressing member.

9. The fixing device according to claim 1, wherein
the pressing member is a pressure cylinder in which a dent into which a gripping portion that grips a front end side of the recording medium enters is formed on a surface side, and
the irregular portion is provided on the surface of the pressure cylinder except for the dent.

10. An image forming system comprising:
an image former that forms a toner image on a recording medium; and
the fixing device according to claim 1, the fixing device fixing the toner image formed by the image former onto the recording medium.

11. An image forming system comprising:
an image former that forms a toner image on a recording medium; and
the fixing device according to claim 1, the fixing device fixing the toner image formed by the image former onto the recording medium.

12. An image forming system comprising:
an image former that forms a toner image on a recording medium; and
the fixing device according to claim 2, the fixing device fixing the toner image formed by the image former onto the recording medium.

13. An image forming system comprising:
an image former that forms a toner image on a recording medium; and
the fixing device according to claim 3, the fixing device fixing the toner image formed by the image former onto the recording medium.

14. An image forming system comprising:
an image former that forms a toner image on a recording medium; and
the fixing device according to claim 4, the fixing device fixing the toner image formed by the image former onto the recording medium.

15. An image forming system comprising:
an image former that forms a toner image on a recording medium; and
the fixing device according to claim 5, the fixing device fixing the toner image formed by the image former onto the recording medium.

16. An image forming system comprising:
an image former that forms a toner image on a recording medium; and
the fixing device according to claim 6, the fixing device fixing the toner image formed by the image former onto the recording medium.

17. An image forming system comprising:
an image former that forms a toner image on a recording medium; and
the fixing device according to claim 7, the fixing device fixing the toner image formed by the image former onto the recording medium.

18. An image forming system comprising:
an image former that forms a toner image on a recording medium; and
the fixing device according to claim 8, the fixing device fixing the toner image formed by the image former onto the recording medium.

19. An image forming system comprising:
an image former that forms a toner image on a recording medium; and
the fixing device according to claim 9, the fixing device fixing the toner image formed by the image former onto the recording medium.

20. An image forming system comprising:
an image former that forms a toner image on a recording medium;
the fixing device according to claim 1, the fixing device fixing the toner image formed on the first face of the recording medium by the image former onto the recording medium and fixing the toner image formed on the second face of the recording medium by the image former onto the recording medium; and
a reverse mechanism that reverses the recording medium from the first face to the second face after the toner image is fixed onto the first face of the recording medium by the fixing device.
